(19) United States
(12) Patent Application Publication
(10) Pub. No.: US 2024/0029526 A1
(43) Pub. Date: Jan. 25, 2024

(54) SIGNALING APPARATUS

(71) Applicant: Mauro TARDIVO, Fogliano Redipuglia (IT)

(72) Inventor: Mauro TARDIVO, Fogliano Redipuglia (IT)

(21) Appl. No.: 18/041,435

(22) PCT Filed: Aug. 12, 2021
(86) PCT No.: PCT/IT2021/050262

§ 371 Date: Feb. 13, 2023

(30) Foreign Application Priority Data
Aug. 13, 2020 (IT) 102020000020134

(51) Int. Cl. G08B 1/08

(52) U.S. Cl. CPC G08B 1/08

(57) ABSTRACT

The Signaling apparatus comprising at least one passive warning device which comprises: a mean for detecting signals and a logic unit which communicates with storage media which contain information describing characteristics of known signals typically present in emergency situations.

### FIELD OF THE INVENTION

The present invention concerns a signaling apparatus to warn one or more users of potentially dangerous situations, in particular that can be used in an open and unconfined environment, to warn a user of the possible approach of a vehicle or to provide indications regarding the position of any people requesting assistance.

The signaling apparatus can be used on vehicles, or in combination with them, to warn one or more users of the fact that they are in a situation of potential danger to themselves and/or to other individuals.

Here and hereafter in the description and the claims, the term vehicle is to be understood in the broadest sense, thus including cars, motorcycles, bicycles, boats, aircraft, or any other type of means of locomotion with at least one user on board.

In an alternative application, the signaling apparatus can also be used in situations where a user is already in a dangerous situation and needs to warn rescue personnel in order to be identified and recovered.

For example, by signaling apparatus we mean a device able to signal in advance that an emergency vehicle, or of the police forces, or in any case a vehicle which has priority of transit, is approaching the vehicle with the user on board, so that the latter can position him/herself in a position of non-interference with respect to said means having priority. Or we mean a device able to signal the position, distance and direction of a person who is no longer able to move, so that he/she can be rescued.

### BACKGROUND OF THE INVENTION

Emergency situations are known and commonly found, in which it is of enormous importance to attract the attention of the public to what is, or could be, a danger.

Examples of such situations may be the passage of an emergency vehicle, such as an ambulance or a security/surveillance body on a busy street, or the rescue of a missing person in hostile environments.

One known solution to attract the attention of the public is the use of visual devices, such as fixed or mobile signs, lights, flashing lights or other.

Another known solution, which can be used in combination with the previous one, can be the use of sound devices, such as for example sirens, loudspeakers, megaphones, whistles or, in some cases, the human voice.

However, there are known problems related to the inability of an individual, for example a rescuer, or a motorist in traffic, to pick up and identify in good time the signals that can warn him of the emergency situation.

In such emergency situations, and in others, a delay due to the ineffectiveness of the solutions to quickly attract the attention of the party involved can also lead to serious consequences.

For example, very often the known solutions are not sufficient to warn a motorist in time of the arrival, and especially of the direction of arrival, of an emergency vehicle. In fact, the driver can be distracted by the car radio, the soundproofing of the vehicle can reduce his perception of sounds coming from outside, or in any case it can be objectively difficult to have the exact perception of the direction of origin of the sound. This can lead to road accidents which, in addition to affecting those directly affected, can also harm other people, for example the patient in an ambulance.

Another example could be situations in which the rescuers are unable to hear and therefore locate a missing person. This may be due both to the limits of human hearing but also to the noise pollution generated by the environment in which they are located or by the rescue vehicles themselves.

Documents US-A1-2019/180735 and US-B1-8917186 concern systems and methods to remotely monitor one or more alarms disposed in fixed and defined positions in confined spaces, and to receive a sound signal based on the alarm activated.

The problem arises of facilitating such sound detections coming from variable positions in open and unconfined environments, and therefore there is a need to perfect a signaling apparatus which can overcome at least one of the disadvantages of the state of the art.

In particular, one purpose of the present invention is to provide a signaling apparatus that allows to warn a user of the fact that he/she is in a situation of potential emergency, for him/herself or for others, with regard to which he/she must take action.

Another purpose of the present invention is to provide an apparatus that allows to transmit more information to a user, compared with known solutions, regarding the emergency situation.

The Applicant has devised, tested and embodied the present invention to overcome the shortcomings of the state of the art and to obtain these and other purposes and advantages.

### SUMMARY OF THE INVENTION

The present invention is set forth and characterized in the independent claim. The dependent claims describe other characteristics of the present invention or variants to the main inventive idea.

In accordance with the above purposes, a signaling apparatus is described that overcomes the limits of the state of the art and eliminates the defects present therein.

In accordance with some embodiments, there is provided an apparatus for signaling potential emergency situations in unconfined environments, comprising at least one passive warning device. The passive warning device can comprise at least:
means for detecting signals of the sound, ultrasound, infrasound, or radio waves type in a determinate frequency band;
a logic unit communicating with the detection means and communicating with storage media.

According to some embodiments, the storage media can contain information describing characteristics of known signals typically present in emergency situations.

According to one aspect of the invention, the logic unit is configured to compare in real time the characteristics of the signals detected by the detection mean with the characteristics of known signals typically present in emergency situations, in order to determine whether a user is in an emergency situation.

According to some embodiments, the passive warning device comprises means for interacting with the user that can be commanded by the logic unit and are configured to communicate to the user that he/she is in an emergency situation.

The signaling apparatus is therefore advantageously suitable to detect sound signals indicative of a possible emergency situation, coming from variable and undefined positions, and provide a signal to indicate whether an emergency situation is potentially present within a determinate monitoring zone around the passive warning device. The monitoring zone can be more or less large, as a function of the detection capacity of the detection means. The monitoring zone can preferably be of a few kilometers.

The logic unit can also be configured to determine the relative position of a source of signals by means of triangulation algorithms of the signals detected by the detection mean.

In possible embodiments, the passive warning device comprises a location module configured to detect the user's geographical position.

Advantageously, in this way, the passive warning device can display on the user interaction means a geographical map with the position of the vehicle and the relative position of the signal source.

According to another aspect of the invention, the signaling apparatus can comprise an active warning device comprising at least one logic unit, an emitter and power supply means.

The active warning device as above can be configured to emit signals with predefined characteristics correlated to the information stored in the storage media of the passive warning device.

In some embodiments, the active warning device comprises a location module configured to detect its geographical position. In this way, the active warning device can be configured to emit a signal that comprises information on the last valid geographical position detected by the location module.

Some embodiments described here also concern a method to signal potential emergency situations in unconfined environments, comprising:
detecting signals of the sound, ultrasound, infrasound, or radio wave type in a determinate frequency band by means of detection means provided on at least one passive warning device;
receiving, substantially in real time, the detected signals in a logic unit of the passive warning device;
comparing the characteristics of the detected signals with predefined information corresponding to known signals typically present in emergency situations stored in storage media;
recognizing a determinate emergency situation within a monitoring zone around the passive warning device, and
signaling to a user the recognized emergency situation by means of interaction means of the passive warning device which can be commanded by the logic unit.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic representation of an embodiment of a part of the apparatus according to the present invention;

FIG. 2 is a schematic representation of an embodiment of another part of the apparatus according to the present invention;

FIG. 3 is a schematic representation of an embodiment of the apparatus according to the present invention in a condition of use;

FIG. 4 is a schematic representation of another embodiment of the apparatus according to the present invention in a condition of use.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

We will now refer in detail to the possible embodiments of the invention, of which one or more examples are shown in the attached drawings, by way of a non-limiting illustration. The phraseology and terminology used here are also for the purposes of providing non-limiting examples.

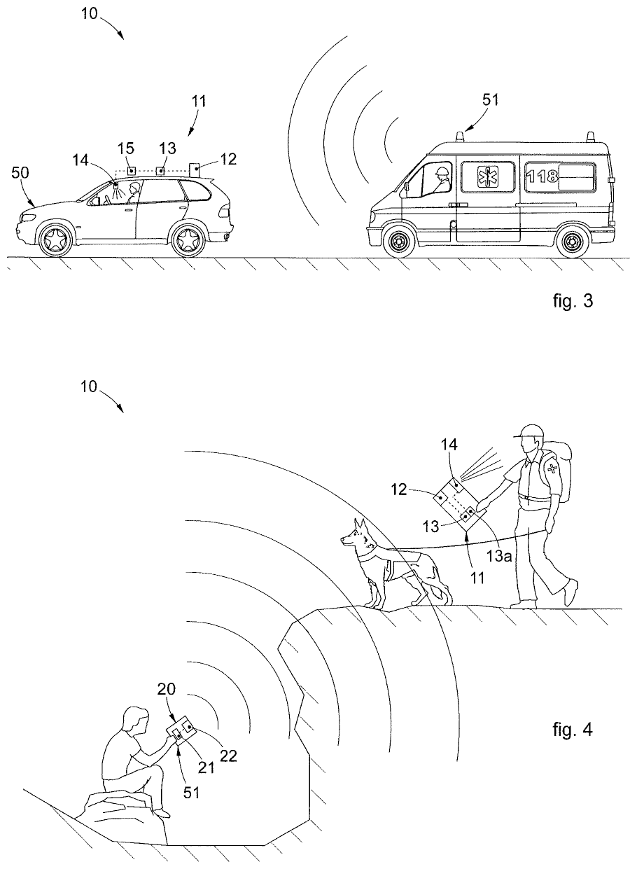

The present invention concerns a signaling apparatus, indicated as a whole with reference number 10 (FIGS. 3 and 4).

In some embodiments, the signaling apparatus 10 can comprise at least one passive warning device 11.

According to some embodiments, the passive warning device 11 can be associated with a vehicle 50, such as for example a car, a motorcycle or a bicycle (FIG. 3).

The passive warning device 11, in other embodiments, can be associated with boats or more generally with watercraft.

In yet other embodiments, the passive warning device 11 can be associated with an aircraft.

In particular, the passive warning device 11 can be associated with the vehicle by means of attachment devices of the mechanical type, for example interlocking devices, or by means of suitable connection means such as screws or bolts. In other embodiments, the passive warning device 11 can be associated with the vehicle 50 by means of attachment devices of the sucker type or of the magnetic type. In yet other embodiments, the attachment device can be integrated in the vehicle 50 as part of the information system thereof.

According to other variants, the passive warning device 11 can be suitable to be transported autonomously by a user, for example by a rescuer (FIG. 4).

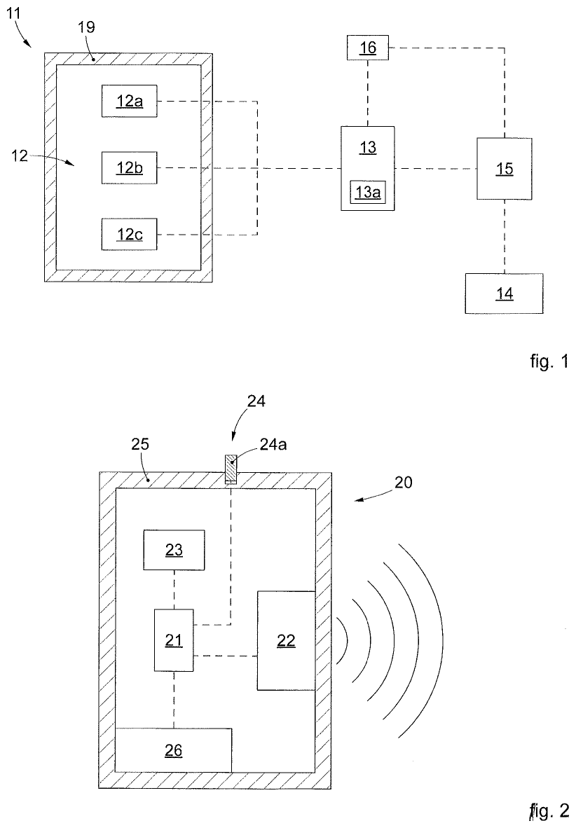

In accordance with some embodiments, the passive warning device 11 can comprise detection means 12, a logic unit 13 and user interaction means 14 (FIG. 1).

In some embodiments, the detection means 12 can be configured to detect signals of the sound and/or ultrasound and/or infrasound type.

In some embodiments, at least the detection means 12 can be contained in a casing 19 transparent to the signals, which the detection means 12 can detect, and can be outside the vehicle 50.

In other embodiments, the entire passive warning device 11 can be contained in a casing 19 that is impermeable to water, at least in the part containing the logic unit 13 and any associated electronics. In addition, the casing 19 can be suitable for direct exposure to meteorological phenomena such as variations in temperature and humidity.

In some embodiments, the logic unit 13 can be of the DSP type or the FPGA type, or it can be a microprocessor, a microcontroller or similar and comparable.

In some embodiments, the detection means 12 can be configured to detect signals in a continuous manner.

In other variants, the signal detection means 12 can be configured to detect signals in an intermittent manner, for example according to predetermined intervals.

In some embodiments, the signal detection means 12 are configured to transmit the detected signals to the logic unit 13.

In accordance with preferred embodiments, the detection means 12 can transmit the detected signals to the logic unit 13 in a continuous manner and substantially in real time.

In other possible embodiments, the detection means 12 can transmit the detected signals to the logic unit 13 in an intermittent manner.

According to some embodiments, the logic unit 13 can be configured to compare characteristics of the signals detected by the detection means 12 with characteristics of signals of a known type.

In particular, in some embodiments, the passive warning device 11 can comprise a storage unit 13a. The logic unit 13 can communicate with the storage unit 13a, which can contain predefined information describing the characteristics of known signals typically present in emergency situations. For example, the storage unit 13a can contain data relating to the signals emitted by the sirens of an ambulance, of a vehicle of a security corps and others.

In other embodiments, the logic unit 13 can also be configured to filter the signals detected by the detection means 12 before the comparison. The filtering can have the purpose of making the subsequent comparison of the detected signal more efficient and effective.

In other embodiments, the logic unit 13 can be configured to evaluate the trend as a function of time of the signals detected by the detection means 12. In particular, the logic unit 13 can evaluate the trend over time of the intensity and phase of one or more signals detected by the detection means 12.

In this specific case, in this way the passive warning device 11 can advantageously determine whether the source 51 of the signal is approaching or moving away from the detection means 12.

In accordance with some embodiments, the signal detection means 12 can comprise a plurality of detectors 12a, 12b, 12c. In particular, in some embodiments, each of the detectors 12a, 12b, 12c can be disposed distanced from the others and in different positions of the vehicle 50 with which the passive warning device 11 is associated.

According to preferred embodiments, the logic unit 13 can be able to determine the relative position of the source 51 of a signal detected by the detection mean 12. By relative position, we mean the position of the source 51 of the signal in relation to that of the detection means 12.

In other embodiments, the logic unit 13 can be suitable to determine the relative speed of the source 51 of a signal detected by the detection means 12.

In this specific case, the logic unit 13 can analyze the signals detected by the detection means 12 by means of triangulation algorithms, in order to determine the position and/or relative speed of the source 51 of the signal.

In some embodiments, the passive warning device 11 can also comprise a communication unit 15 configured to communicate with a location module 16.

In some embodiments, the communication unit 15 can be of the DSP type or of the FPGA type, or it can be a microprocessor, a microcontroller or similar and comparable.

The location module 16 can be configured to determine the geographical position of the passive warning device 11. In particular, the location module 16 can be configured to interface with GPS, Glonass and/or Galileo infrastructures.

In other embodiments, the location module 16 can be configured to also detect the speed, and possibly the direction, of the displacement of the passive warning device 11. The information on speed and direction of the displacement of the passive warning device 11 can be transmitted to the logic unit 13.

In some embodiments, the logic unit 13 can evaluate the trend over time of the intensity and phase of one or more signals detected by the detection means 12, and the information on speed and direction of the passive warning device 11, in order to determine whether the source 51 of the signal is approaching or moving away from the detection means 12.

According to one aspect of the invention, the logic unit 13 can be configured to command the user interaction means 14, possibly by means of the communication unit 15, in order to warn the user of the presence of a signal possibly attributable to a situation of danger. In particular, the warning can occur in the event that the comparison between the detected signal and the signals of a known type, typically present in emergency situations, gives a positive result. More in particular, once the comparison has been made between the signals detected by the detection means 12 and the characteristics of the known signals present in the storage media 13a, the logic unit 13 can be configured to evaluate whether the detected signals are characteristic of a situation of danger and therefore whether it is necessary to warn the user.

Should it be necessary to warn the user, the logic unit 13 can command the user interaction means 14 in order to effectively communicate any possible emergency to the user.

The warning can be of the sound type, for example a voice message or emergency sound, or of the text type, or in graphic form with signaling icons.

In some embodiments, the user interaction means 14 can be configured as sound devices such as speakers and/or luminous devices such as LEDs, bulbs or screens.

In other embodiments, the user interaction means 14 can be configured as the screen of a telephone connected to the logic unit 13 by means of the communication unit 15.

In still other embodiments, the user interaction means 14 can be configured as a screen of the information system of the vehicle 50 with which the passive warning device 11 is associated.

In preferred embodiments, the passive warning device 11 can determine the geographical position of the vehicle 50 by means of the location module 16, and the relative position of the source 51 of the signal by means of the detection means 12 and the logic unit 13.

Advantageously, in this way, the passive warning device 11 can display on the user interaction means 14 a geographical map with the geographical position of the vehicle 50 and the relative position of the source 51 of the signal.

In some embodiments, the user can configure, by means of the user interaction means 14, the modes according to which to be notified by the passive warning device 11.

The modes as above can depend on the characteristics of the detected signal, such as for example the intensity and phase thereof, and/or on the relative position of the source 51, that is, the distance between the source 51 and the vehicle 50. In fact, the user can, for example, choose to be notified if the strength of a detected signal is increasing. In this way, the user is given the opportunity to discard signals of constant or decreasing intensity. Alternatively, the user can choose to be warned if the relative position of the source 51 of the signal is within a certain distance radius from the vehicle 50. However, we do not exclude other warning modes, depending for example on the detected direction and/or speed of displacement of the source 51.

According to another aspect of the invention, the signaling apparatus 10 can also comprise an active warning device 20 mating with the passive warning device 11.

In accordance with some embodiments, the active warning device 20 can be configured to emit signals.

According to some embodiments, the active warning device 20 comprises at least a control unit 21, an emitter 22 and power supply means 23 (FIG. 2).

In some embodiments, the control unit 21 can be of the DSP type or of the FPGA type, or it can be a microprocessor, a microcontroller or similar and comparable.

In accordance with some embodiments, the emitter 22 can be configured to emit sound signals, that is, with frequencies comprised between 16 Hz and 20,000 Hz.

In some embodiments, the emitter 22 can be configured to emit signals of the ultrasound type, that is, with frequencies higher than 20,000 Hz.

In other embodiments, the emitter 22 can be configured to emit signals of the infrasound type, that is, with frequencies lower than 16 Hz.

According to other embodiments, the emitter 22 can be configured to emit signals in the form of radio waves within a determinate frequency, preferably corresponding to the frequency normally used by rescue services such as firefighters, ambulances, police and suchlike, for example between 25 and 50 MHz.

It should be noted that the active warning device 20 can therefore constitute a source 51 of signals which is detectable by the passive warning system 11.

In some embodiments, the control unit 21 can be configured to generate the signal that will be emitted by the emitter 22.

In fact, in preferred embodiments, the emitter 22 can be configured to emit signals with characteristics at least partly correlated to the information stored in the storage media 13a of the passive warning device 11.

In some embodiments, the control unit 21 can be configured to activate and/or deactivate the emitter 22.

In some embodiments, the active warning device 20 can be equipped with a location module 26. In particular, the location module 26 can be configured to interface with the GPS, Glonass and/or Galileo infrastructures.

The location module 26 can be configured to detect the geographical position of the active warning device 20.

In the above embodiments, the emitter 22 can be configured to emit signals that communicate the last valid coordinates detected by the location module 26.

According to some embodiments, the power supply means 23 can be configured as energy accumulators, such as for example batteries.

In other embodiments, the power supply means 23 can comprise photovoltaic panels in combination with energy accumulators.

In this way, the power supply means 23 guarantee that the active warning device 20 is portable.

In other embodiments, the power supply means 23 can be suitable to connect to an external power input unit.

In some embodiments, the active warning device 20 can also comprise a user interface 24.

According to particular embodiments of the active warning device 20, the user interface 24 can comprise at least one key 24a configured to activate and/or deactivate the emitter 22. In particular, the user interface 24 can be connected to the control unit 21, which will activate or deactivate the emitter once the command from the key 24a has been received.

The presence of additional keys is not excluded, for example connected to the power supply means 23 and suitable to switch the active warning device 20 on/off.

In other embodiments, the user interface 24 can comprise screens and/or luminous devices configured to display information on the operating state of the active warning device 20. By operating state we mean the set of functioning parameters of the device 20, such as the state of charge of the power supply means 23, whether the signal is being emitted by the emitter 22, the on/off state of the active warning device 20, or other.

In preferred embodiments, the active warning device 20 can be entirely contained in a casing 25.

The casing 25 can be, in some embodiments, impermeable to water and/or dust. In particular, the casing 25 can have a degree of protection corresponding at least to IP66.

In some embodiments, the active warning device 20 can be preemptively associated, for example, with hiking backpacks, mountain equipment, life jackets, life-saving vests, rubber boats, inflatable arm bands or other.

Advantageously, in this way, the apparatus 10 can also make search operations for individuals missing in hostile environments more effective and efficient (FIG. 4).

A method to signal potential emergency situations in unconfined environments according to the invention comprises:
detecting signals of the sound, ultrasound, infrasound, or radio wave type in a determinate frequency band by means of detection means 12 provided on the passive warning device 11;
receiving, substantially in real time, the detected signals in the logic unit 13 of the passive warning device 11;
comparing the characteristics of the detected signals with predefined information corresponding to known signals typically present in emergency situations stored in the storage media 13a;
recognizing a determinate emergency situation within a monitoring zone around the passive warning device 11, and
reporting to a user the emergency situation recognized, by means of interaction means 14 of the passive warning device 11 which can be commanded by the logic unit 13.

The method according to the invention also comprises detecting a plurality of signals independently of each other and communicating them to the logic unit 13, in order to determine the relative position of a source 51 of the signals by means of triangulation algorithms of the detected signals.

According to some embodiments, the signaling method provides to detect the geographical position of the passive warning device 11 and to display on the user interaction means 14 a map depicting the position of the source 51 in relation to the geographical position of the passive warning device 11.

According to other embodiments, the method provides to receive signals emitted by an active warning device 20 which comprises an emitter 22 configured to emit signals of the sound and/or ultrasound, and/or infrasound and/or radio waves type in a determinate frequency band, having predefined characteristics and at least partly correlated to known signals typically present in emergency situations relating to the information stored on the storage media 13a of the passive warning device 11.

According to other embodiments, the method provides to detect the geographical position of the active warning device 20 and emit, by means of the emitter 22, a signal comprising information relating to the last valid geographical position detected by the location module 26.

It is clear that modifications and/or additions of parts may be made to the signaling apparatus 10 and method as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. An apparatus for signaling potential emergency situations in unconfined environments, comprising at least one passive warning device which comprises detection means configured to detect signals of the sound, ultrasound, infrasound or radio waves type in a determinate frequency band, a logic unit communicating with said detection means and configured to receive substantially in real time the signals detected by said detection means and storage media containing predefined information describing characteristics of known signals typically present in emergency situations, wherein said logic unit is configured to compare the characteristics of said detected signals with said predefined information corresponding to known signals typically present in emergency situations, recognize a determinate emergency situation within a monitoring zone around said passive warning device and signal to a user said recognized emergency situation by means of interaction means of said passive warning device which can be commanded by said logic unit.

2. The signaling apparatus as in claim 1, wherein said detection means comprise a plurality of detectors configured to detect signals independently of each other and communicate them to said logic unit.

3. The signaling apparatus as in claim 2, wherein said logic unit is configured to determine the relative position of a source of signals by means of triangulation algorithms of said signals detected by said detectors.

4. The signaling apparatus as in claim 1, wherein said passive warning device comprises a location module configured to detect the geographical position of said passive warning device.

5. The signaling apparatus as in claim 3, wherein said passive warning device is configured to display on the user interaction means a map depicting the position of said source in relation to the geographical position of said passive warning device.

6. The signaling apparatus as in claim 1 and also comprising an active warning device that comprises an emitter configured to emit signals of the sound and/or ultrasound and/or infrasound and/or radio waves type in a determinate frequency band and a control unit configured to activate and/or deactivate said emitter, wherein said control unit is configured to generate a signal, emitted by said emitter, with predefined characteristics at least partly correlated to known signals typically present in emergency situation, relating to said information stored in said storage media of said passive warning device.

7. The signaling apparatus as in claim 6, wherein said active warning device comprises a location module configured to detect the geographical position of said active warning device.

8. The signaling apparatus as in claim 7, wherein said active warning device is configured to emit, by means of said emitter, a signal comprising information relating to the last valid geographical position detected by said location module.

9. The signaling apparatus as in claim 6, wherein said active warning device is contained in a casing with a degree of protection corresponding to at least IP66.

10. A method to signal potential emergency situations in unconfined environments, comprising:
detecting signals of the sound, ultrasound, infrasound, or radio wave type in a determinate frequency band by means of detection means provided on at least one passive warning device;
receive, substantially in real time, said detected signals in a logic unit of said passive warning device;
compare the characteristics of said detected signals with predefined information corresponding to known signals typically present in emergency situations stored in storage media;
recognize a determinate emergency situation within a monitoring zone around said passive warning device, and
signal to a user said recognized emergency situation by means of interaction means of said passive warning device which can be commanded by said logic unit.

11. The method as in claim 10, wherein it provides to detect a plurality of signals independently of each other and communicate them to said logic unit in order to determine the relative position of a source of signals by means of triangulation algorithms of said detected signals.

12. The method as in claim 11, wherein it provides to detect the geographical position of said passive warning device and display on the user interaction means a map depicting the position of said source in relation to the geographical position of said passive warning device.

13. The method as in claim 11, wherein it provides to evaluate the trend as a function of time of at least one of either the intensity or phase of the signals detected by the detection means and determine whether the source of the signal is approaching or moving away from said detection means.

14. The method as in claim 10, wherein it provides to receive signals emitted by an active warning device which comprises an emitter configured to emit signals of the sound and/or ultrasound, and/or infrasound and/or radio waves type in a determinate frequency band, having predefined characteristics and at least partly correlated to known signals typically present in emergency situations, relating to said information stored in said storage media of said passive warning device.

15. The method as in claim 14, wherein it provides to detect the geographical position of said active warning device and emit, by means of said emitter, a signal comprising information relating to the last valid geographical position detected by said location module.
